(19) United States
(12) Patent Application Publication
(10) Pub. No.: US 2026/0336527 A1
(43) Pub. Date: Oct. 29, 2026

(54) STOWABLE TAILGATE COVER AND CARGO TRAY

(71) Applicant: Toyota Motor Engineering & Manufacturing North America, Inc., Plano, TX (US)

(72) Inventors: Paxton S. Williams, Milan, MI (US); Scott Louis Frederick, Brighton, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/190,060

(22) Filed: Apr. 25, 2025

(51) Int. Cl. B60R 9/06; B60R 11/00

(52) U.S. Cl. CPC B60R 9/06; B60R 2011/0071; B60Y 2200/14

(57) ABSTRACT

A vehicle includes a tailgate assembly including a tailgate panel movable between an open position and a closed position. The tailgate panel includes a first tailgate surface facing outward when the tailgate panel is in the closed position and a second tailgate surface facing inward when the tailgate panel is in the closed position. The tailgate assembly further includes a tailgate panel cover operatively coupled to the tailgate panel and disposed at the first tailgate surface. The tailgate panel cover is moveable with respect to the tailgate panel between a stowed position and a deployed position. The tailgate panel includes a first adapter panel having first and second surfaces. In response to the tailgate panel cover moving to the stowed position, the first adapter panel is disposed between the first tailgate surface and the tailgate panel cover.

### BACKGROUND

### 1. Field

The various aspects and embodiments described herein relate generally to vehicle accessories and, in particular, to cargo carriers for vehicles.

### 2. Description of the Related Art

Some vehicles, such as pickup trucks, have truck beds for carrying loads and tailgates for retaining the loads in or on the beds. The tailgate is generally moveable between a closed position, with the tailgate in an up or vertical position, and an open position, with the tailgate in a down or horizontal position. When a tailgate is in an up or vertical orientation, the tailgate serves to confine the load to the truck bed area. The tailgate is generally lowered in order to load and unload the truck bed. There may be times, however, when there is not enough space in the truck bed to fit a load. In order to expand the load capacity of the vehicle, after market cargo trays exist that couple to a hitch of the vehicle. When not in use, the cargo tray must be stored away separately, for example, taking up valuable space in a user's home or garage.

In this respect, it would be desirable if a device were provided that extends cargo capacity of a vehicle without taking up valuable house or garage space.

### SUMMARY

In general, one aspect of the subject matter described in this disclosure may be embodied in a vehicle. The vehicle includes a tailgate assembly. The tailgate assembly includes a tailgate panel and a tailgate panel cover is operatively coupled to the tailgate panel. The tailgate panel is movable between an open position and a closed position. The tailgate panel includes a first tailgate surface facing outward when the tailgate panel is in the closed position and a second tailgate surface facing inward when the tailgate panel is in the closed position. The tailgate panel cover is disposed at the first tailgate surface. The tailgate panel cover is moveable with respect to the tailgate panel between a stowed position and a deployed position. The tailgate panel includes a first adapter panel having first and second surfaces. In response to the tailgate panel cover moving to the stowed position, the first adapter panel is disposed between the first tailgate surface and the tailgate panel cover.

In another aspect, the subject matter may be embodied in a tailgate assembly for a vehicle. The tailgate assembly includes a tailgate panel and a tailgate panel cover is operatively coupled to the tailgate panel. The tailgate panel is movable between an open position and a closed position. The tailgate panel includes a first tailgate surface facing outward when the tailgate panel is in the closed position and a second tailgate surface facing inward when the tailgate panel is in the closed position. The tailgate panel cover is disposed at the first tailgate surface. The tailgate panel cover is moveable with respect to the tailgate panel between a stowed position and a deployed position. The tailgate panel includes a first adapter panel having first and second surfaces. In response to the tailgate panel cover moving to the stowed position, the first adapter panel is disposed between the first tailgate surface and the tailgate panel cover.

In another aspect, the subject matter may be embodied in a method of using a tailgate assembly for a vehicle. The method includes, with the tailgate assembly in a closed position, transitioning a tailgate panel cover from a stowed position to a deployed position to expose an adapter panel having first and second surfaces and at least one series of apertures extending completely through the first and second surfaces of the adapter panel. The method further includes forming a substantially horizontal surface with the tailgate panel cover in response to the tailgate panel cover transitioning to the deployed position, and the horizontal surface is configured to support cargo for transporting with the vehicle.

These and other embodiments may optionally include one or more of the following features.

In various aspects, in response to the tailgate panel cover moving to the stowed position, the first adapter panel is hidden from view behind the tailgate panel cover.

The tailgate assembly can further include at least one series of apertures extending completely through the first and second surfaces of the first adapter panel, the at least one series of apertures is sized and configured for receiving a strap for securing an object to the tailgate panel cover. The at least one series of apertures can be sized and positioned to engage at least one attachment strap, such as a MOLLE®-type attachment strap, for securing the object against one of the first or second surfaces of the first adapter panel.

The tailgate panel cover can be pivotally coupled to the tailgate panel, in the stowed position the tailgate panel cover is folded against the tailgate panel, and in the deployed position the tailgate panel cover is folded away from the tailgate panel.

The tailgate assembly can further include a second adapter panel coupled to the first tailgate surface of the tailgate panel. The second adapter panel can be configured for securing an object to the tailgate panel cover. The tailgate panel cover can be configured to cover the second adapter panel in response to the tailgate panel cover moving to the stowed position.

The vehicle can further include a pair of rails configured to extend aft from a rear bumper of the vehicle, the pair of rails includes a first rail and a second rail, and in the deployed position the tailgate panel cover is configured to extend between and to the first rail and the second rail. The first and second rails can be telescoping rails. The first and second rails can be folding rails.

The tailgate panel cover can include a release handle operatively coupled to a latch bolt for moving the latch bolt between an extended position and a retracted position. The latch bolt can be configured to engage the tailgate panel for locking the tailgate panel cover to the tailgate panel. The latch bolt can be configured to engage at least one of the first rail and/or the second rail for locking the tailgate panel cover to the at least one of the first rail and/or the second rail in the deployed position.

The tailgate assembly can further include a spring-loaded hinge pin configured to engage the tailgate panel for pivotally coupling the tailgate panel cover to the tailgate panel. The spring-loaded hinge pin can be retractable for releasing the tailgate panel cover from the tailgate panel.

In response to the tailgate panel cover moving to the stowed position, the first adapter panel can be hidden from view behind the tailgate panel cover.

The tailgate panel cover can include a release handle operatively coupled to a latch bolt for moving the latch bolt between an extended position and a retracted position. The latch bolt can be configured to engage the tailgate panel for locking the tailgate panel cover to the tailgate panel. The latch bolt can be configured to engage at least one of the first rail and/or the second rail for locking the tailgate panel cover to the at least one of the first rail and/or the second rail in the deployed position.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

Other apparatuses, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 illustrates a perspective view of a vehicle according to an aspect of the present disclosure.

FIG. 2A illustrates a tailgate assembly in a closed position and having a tailgate panel cover in a stowed position according to an aspect of the present disclosure.

FIG. 2B illustrates the tailgate assembly of FIG. 2A in an open position according to an aspect of the present disclosure.

FIG. 2C illustrates the tailgate assembly of FIG. 2A in a closed position and having the tailgate panel cover in a deployed position according to an aspect of the present disclosure.

FIG. 2D illustrates a section view of the tailgate assembly with the tailgate panel in the closed or vertical position and showing the tailgate panel cover movable between the stowed and deployed positions according to an aspect of the present disclosure.

FIG. 3 illustrates a side view of a tailgate panel cover having an adapter panel according to an aspect of the present disclosure.

FIG. 4 illustrates a top view of an adapter panel according to an aspect of the present disclosure.

FIG. 5 illustrates a schematic view of a latch assembly for a tailgate panel cover according to an aspect of the present disclosure.

FIG. 6 illustrates a section view of a tailgate assembly with the tailgate panel in the closed or vertical position and showing the tailgate panel cover in a deployed position and supported by a cable assembly according to an aspect of the present disclosure.

FIG. 7A illustrates a tailgate assembly having a tailgate panel in a closed position, a pair of support rails extending from a rear bumper, and a removable tailgate panel cover being installed to the pair of support rails according to an aspect of the present disclosure.

FIG. 7B illustrates the tailgate assembly with the tailgate panel cover installed to the pair of support rails according to an aspect of the present disclosure.

FIG. 8 is a flow diagram of an example process of using a tailgate assembly for a vehicle according to an aspect of the present disclosure.

FIG. 9 illustrates a schematic view of a retractable hinge mechanism for a tailgate panel cover according to an aspect of the present disclosure.

### DETAILED DESCRIPTION

Disclosed herein are apparatus, systems, and methods for implementing a tailgate assembly for a vehicle. The tailgate assembly includes a multi-panel arrangement including a primary tailgate panel pivotally coupled to the vehicle and an outer tailgate panel cover pivotally and/or removably coupled to the primary tailgate panel. The tailgate panel cover is configured to be deployed in an open or horizontal position when the primary tailgate panel is in a closed or vertical position so as to provide a support and/or tie-down surface for securing a load to the vehicle. In various aspects, the tailgate panel cover can be released relative to the primary tailgate panel with the use of a handle. The tailgate panel and the tailgate panel cover can include panels such as MOLLE®-style panels, for securing cargo. Pivoting the tailgate panel cover exposes the MOLLE®-style panel(s) of the tailgate panel cover. The tailgate panel cover can be removed from the tailgate with a hinge release incorporated into the tailgate panel cover. The released tailgate panel cover can be mounted onto support rails extending from a rear of the vehicle.

The apparatus, systems, and methods described herein eliminate the need to separately store a cargo tray and instead the tailgate panel cover is stowed on the tailgate. The tailgate panel cover and the adapter panel located on the tailgate can provide two surfaces (one horizontal surface and one vertical surface) for tying down cargo to the vehicle. In various aspects, the pair of support rails are retractable or foldable into the rear bumper so as to eliminate the need to separately store the support rails.

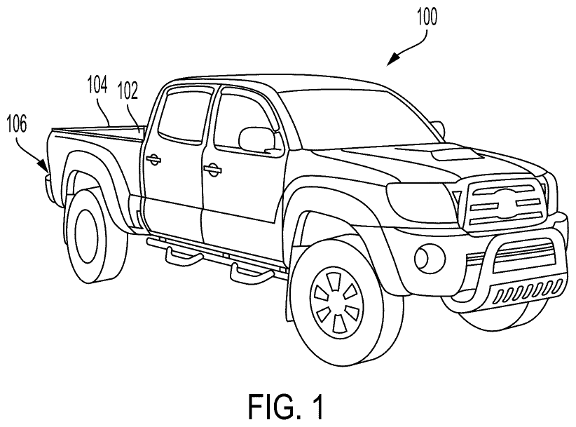

FIG. 1 illustrates a perspective view of a vehicle 100 to be used with a tailgate system, in accordance with various aspects. The vehicle 100 is a conveyance capable of transporting a person, an object, or a permanently or temporarily affixed apparatus. The vehicle 100 may have an automatic or manual transmission. The vehicle 100 may be a self-propelled wheeled conveyance, such as a pick-up truck, an SUV, a UTV, a minivan, a station wagon, or other motor or battery driven vehicle. For example, the vehicle 100 may be an electric vehicle, a hybrid vehicle, a plug-in hybrid vehicle, a fuel cell vehicle, or any other type of vehicle that includes a motor/generator. FIG. 1 depicts a pick-up truck by example. The vehicle 100 may be an autonomous or semi-autonomous vehicle having self-driving capabilities. The vehicle 100 may have a truck bed 102 enclosed by a tailgate 104 (also referred to herein as a tailgate assembly) from a rear end 106. The truck bed 102 may have an open top or a closed top. The truck bed 102 may be suitable to store and transport cargo. The truck bed 102 may accommodate cargo. In various aspects, the tailgate 104 may enclose a trunk (e.g., for a sedan or SUV). The tailgate 104 may be manufactured from metal, glass, plastic, a composite material, and/or wood.

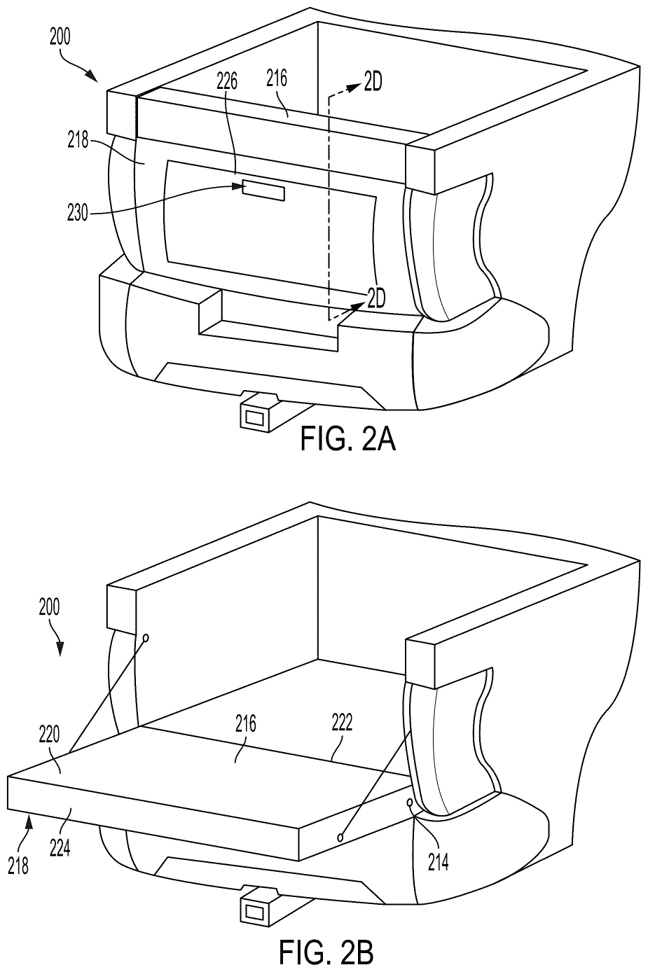

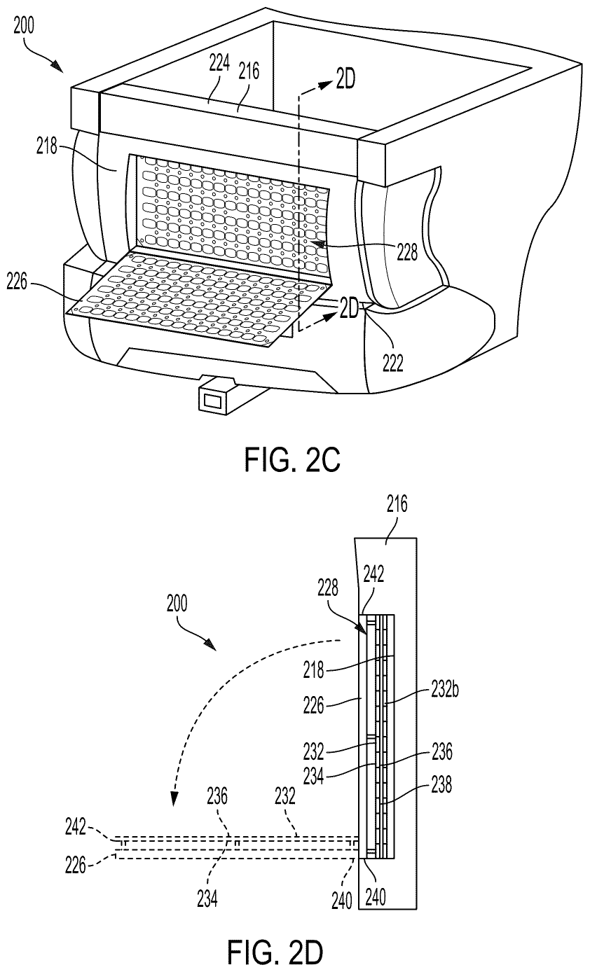

FIGS. 2A and 2B show views of a tailgate assembly 200 coupled to a vehicle in a closed position and an open position, respectively. The tailgate assembly 200 can be similar to the tailgate 104 of FIG. 1 in accordance with various aspects. The tailgate assembly 200 generally includes a tailgate panel 216 movable between an open position (see FIG. 2B) and a closed position (see FIG. 2A). The tailgate panel 216 includes a first tailgate surface 218 facing outward when the tailgate panel 216 is in the closed position and a second tailgate surface 220 facing inward when the tailgate panel 216 is in the closed position. In various aspects, the first tailgate surface 218 can face downward when the tailgate panel 216 is in the open position and the second tailgate surface 220 can face upward when the tailgate panel 216 is in the open position.

In various aspects, the tailgate panel 216 is attached to the vehicle 100 on a pivotal connection, e.g., a hinge mechanism 214, which permits rotary motion of the tailgate assembly 200 between the closed position and the open position and vice versa. The tailgate panel 216 includes a proximal end 222 and a distal end 224. The tailgate panel 216 can be pivotally coupled to the vehicle 100 at the proximal end 222.

The tailgate assembly 200 can further include a tailgate panel cover 226 operatively coupled to the tailgate panel 216. The tailgate panel cover 226 can be disposed at the first tailgate surface 218. The tailgate panel cover 226 can be disposed between the distal end 224 and the proximal end 222. The tailgate panel cover 226 is moveable with respect to the tailgate panel 216 between a stowed position (see FIG. 2A) and a deployed position (see FIG. 2C). In FIG. 2A, the tailgate panel cover 226 is in a closed or stowed position and is co-planar with the tailgate panel 216.

FIG. 2C shows the tailgate panel cover 226 in a fully open or deployed position. In the deployed position, the tailgate panel cover 226 can be substantially perpendicular (e.g., between eighty-five and ninety-five degrees) with respect to the tailgate panel 216. The tailgate panel 216 contains a recess 228 into which the tailgate panel cover 226 pivots when being closed. The recess 228 is disposed in the first tailgate surface 218. With momentary reference to FIG. 2A, the tailgate panel cover 226 can include a grasping area or handle 230 that may be grasped by the hand of a user to pivot or otherwise move the tailgate panel cover 226 to an open position. In various aspects, the tailgate panel cover 226 can be moved using an automated process, for example, using one or more electric motors.

FIG. 2D shows a section view of the tailgate assembly 200, in accordance with various aspects. In FIG. 2D, the tailgate panel cover 226 is shown with solid lines in the closed position and is shown with dashed lines in the open position. The tailgate panel cover 226 can include an adapter panel 232 coupled thereto and having first and second surfaces 234, 236. The adapter panel 232 can include at least one series of apertures 238 extending completely through the first and second surfaces 234, 236 of the adapter panel 232.

With combined reference to FIG. 2C and FIG. 2D, the tailgate panel cover 226 can be attached to the tailgate panel 216 on a pivotal connection, e.g., a hinge mechanism, which permits rotary motion of the tailgate panel cover 226 between the closed position (see FIG. 2A) and the open position (see FIG. 2C) and vice versa. The tailgate panel cover 226 includes a proximal end 240 and a distal end 242. The tailgate panel cover 226 can be pivotally coupled to the tailgate panel 216 at the proximal end 240. In response to the tailgate panel cover 226 moving to the stowed position, the adapter panel 232 is disposed between the first tailgate surface 218 and the tailgate panel cover 226. In the stowed position, the tailgate panel cover 226 can be folded against the tailgate panel 216. In the deployed position, the tailgate panel cover 226 can be folded away from the tailgate panel 216.

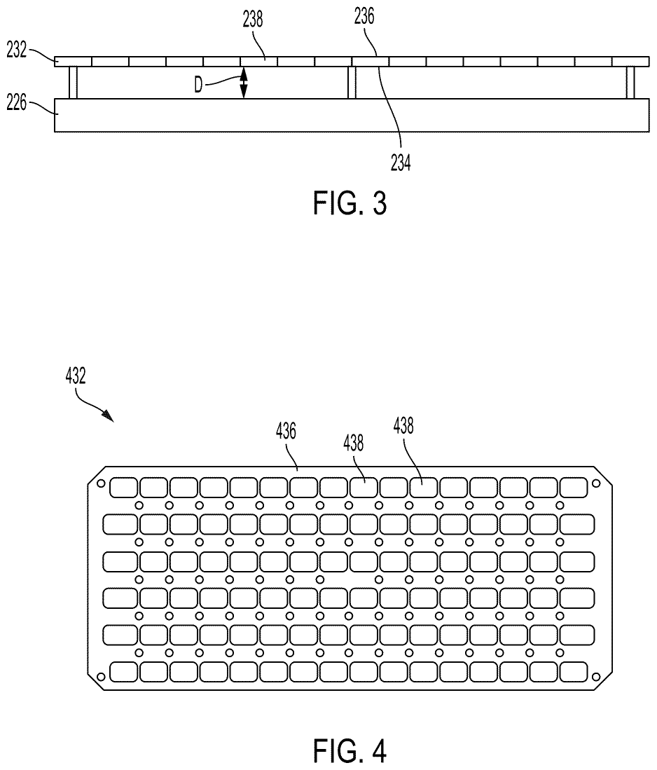

FIG. 3 is a side view of the tailgate panel cover 226, in accordance with various aspects. The first surface 234 of the adapter panel 232 can be spaced apart from the tailgate panel cover 226 by a distance D so as to allow space for straps to be passed through the apertures 238 for securing items and/or cargo to the adapter panel 232. The distance D can be between one eighth inch and two inches (3.175 mm-50.8 mm) in accordance with various aspects, between one quarter inch and one inch (6.35 mm-25.4 mm) in accordance with various aspects, or between one half inch and one inch (12.7 mm-25.4 mm) in accordance with various aspects. The distance D can be sized to allow a webbing or strap to be passed between the first surface 234 of the adapter panel 232 and the tailgate panel cover 226. The adapter panel 232 can be coupled to the tailgate panel cover 226 using standoff supports, such as bolts, pins, rods, or any other suitable standoff that separates the adapter panel 232 from the tailgate panel cover 226.

FIG. 4 is a top view of an example adapter panel 432 for a tailgate assembly, in accordance with various embodiments. The adapter panel 232 described herein can be similar to the adapter panel 432, in accordance with various aspects. The adapter panel 432 can be a flat panel having a surface 436 with at least one series of pre-cut apertures or slots. Each series of apertures 438 can be sized and positioned to accommodate a standard attachment strap of an attachment system, such as a MOLLE® attachment system. The adapter panel 432 may include a plurality of series of apertures 438, arranged in a grid or pattern of any desired configuration to accommodate attached articles having multiple attachment straps such as multiple MOLLE®-type attachment straps. The at least one series of apertures 438 can be sized and positioned to engage at least one attachment strap, such as a MOLLE®-type attachment strap, for securing one or more objects against the surface 436.

With reference again to FIG. 2D, with the tailgate panel cover 226 in the open or deployed position, the tailgate panel cover 226 acts as a cargo carrier for securing items the exterior of the tailgate panel 216. Stated differently, the tailgate panel cover 226 assists in securing items outside of the truck bed and forms a bottom surface for items to be secured to the tailgate panel 216. The tailgate panel 216 can include a second adapter panel 232b. The second adapter panel 232b can be disposed in the recess 228. The second adapter panel 232b can be mounted to the first tailgate surface 218. The second adapter panel 232b can be spaced apart from the first tailgate surface 218 in a similar manner that the adapter panel 232 is spaced apart from the first surface 234 so as to allow straps and/or webbing to pass between the second adapter panel 232b and the first tailgate surface 218 for securing cargo to the second adapter panel 232b. The second adapter panel 232b can be co-planar with the tailgate panel 216. In response to the tailgate panel cover 226 moving to the closed or stowed position, the adapter panel 232 can be oriented parallel to the second adapter panel 232b. In response to the tailgate panel cover 226 moving to the closed or stowed position, the second adapter panel 232b can be hidden from view behind the tailgate panel cover 226. In response to the tailgate panel cover 226 moving to the closed or stowed position, the first adapter panel 232 can be hidden from view behind the tailgate panel cover 226.

In various aspects, the adapter panel 232 forms a bottom support and the second adapter panel 232b forms a side support. Items can be secured to the adapter panel 232 and/or the second adapter panel 232b for providing secure points of attachment to the tailgate assembly 200.

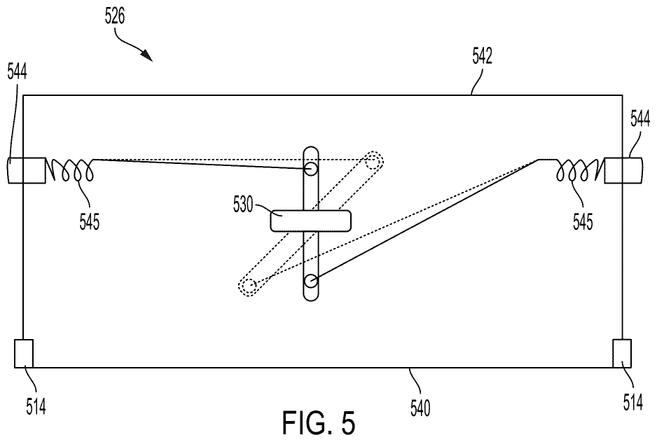

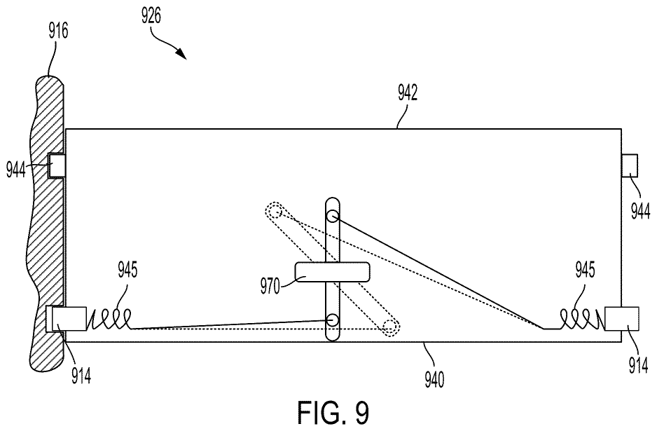

FIG. 5 is a schematic view of a tailgate panel cover 526, in accordance with various aspects. The tailgate panel cover 526 can be similar to the tailgate panel cover 226 described herein, in accordance with various aspects. In various aspects, the tailgate panel cover 526 is attached to the tailgate panel on a pivotal connection, e.g., a hinge mechanism 514, which permits rotary motion of the tailgate panel cover 526 between the stowed or closed position and the deployed or open position and vice versa. In various aspects, the hinge mechanism 514 can be releasable from the tailgate at a predetermined rotational position of the tailgate panel cover 526 with respect to the tailgate panel. In various aspects, the hinge mechanism 514 can be retractable as described with respect to FIG. 9. The tailgate panel cover 526 includes a proximal end 540 and a distal end 542. The tailgate panel cover 526 can be pivotally coupled to the tailgate panel at the proximal end 540. The hinge mechanism 514 can be disposed at the proximal end 540.

The tailgate panel cover 526 can include a handle 530 that may be grasped by the hand of a user to pivot or otherwise move the tailgate panel cover 526 between the stowed and deployed positions. The handle 530 can be operatively coupled to one or more latch bolts 544 configured to engage a catch in the tailgate panel for securing the tailgate panel cover 526 in the stowed position. The handle 530 can be operatively coupled to a pair of opposing latch bolts 544, with a first latch bolt 544 disposed at a first side of the tailgate panel cover 526 and a second latch bolt 544 disposed at a second side of the tailgate panel cover 526. The handle 530 can be operated (e.g., by twisting, rotating, pushing, or pulling the handle 530) to cause the latch bolts 544 to retract into the tailgate panel cover 526 to move the tailgate panel cover 526 from the stowed position to the deployed position. Each latch bolt 544 can be a spring-loaded latch bolt that is biased toward the extended position via a spring member 545.

In various aspects, the hinge mechanism 514 includes a spring-loaded hinge pin assembly for securing and releasing the tailgate panel cover 526 from the tailgate panel 916. For example, with reference to FIG. 9, a tailgate panel cover 926 is illustrated having a spring-loaded hinge mechanism. The tailgate panel cover 926 can be similar to the tailgate panel cover 526 described herein, except that a handle 970 is operatively coupled to a pair of hinge pins 914 (also referred to herein as a hinge mechanism). The handle 970 can be operated (e.g., by twisting, rotating, pushing, or pulling the handle 970) to cause the hinge pins 914 to retract into the tailgate panel cover 926 to release the tailgate panel cover 926 from the tailgate panel 916. In various aspects, the tailgate panel cover 926 is attached to the tailgate panel 916 on a pivotal connection, e.g., the hinge pins 914, which permits rotary motion of the tailgate panel cover 926 between the stowed or closed position and the deployed or open position and vice versa. The tailgate panel cover 926 includes a proximal end 940 and a distal end 942. The tailgate panel cover 926 can be pivotally coupled to the tailgate panel 916 at the proximal end 940. The hinge pins 914 can be disposed at the proximal end 940. Each hinge pin 914 can be a spring-loaded hinge pin that is biased toward the extended position via a spring member 945.

The tailgate panel cover 926 can further include latch bolts 944. The latch bolts 944 can be similar to the latch bolts 544 described with respect to FIG. 5. The latch bolts 944 can be disposed at or near the distal end 942. The latch bolts 944 can be disposed closer to the distal end 942 than to the proximal end 940.

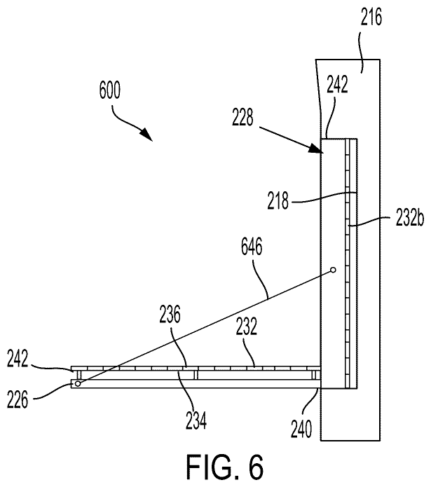

FIG. 6 shows the tailgate panel cover 226 in a deployed position. With respect to FIG. 6, elements with like element numbering, as depicted in FIG. 2D, are intended to be the same or similar and will not necessarily be repeated for the sake of clarity. The tailgate assembly 600 can be similar to the tailgate assembly 200 described with respect to FIG. 2D, except the tailgate panel cover 226 is secured in the deployed position (e.g., a horizontal orientation substantially perpendicular to the tailgate panel 216) via one or more cable assemblies 646. The cable assembly 646 helps to support the tailgate panel cover 226 when the second surface 236 of the adapter panel 232 is used as a cargo rack. The cable assembly 646 can extend between and to the distal end 242 of the tailgate panel cover 226 and the tailgate panel 216.

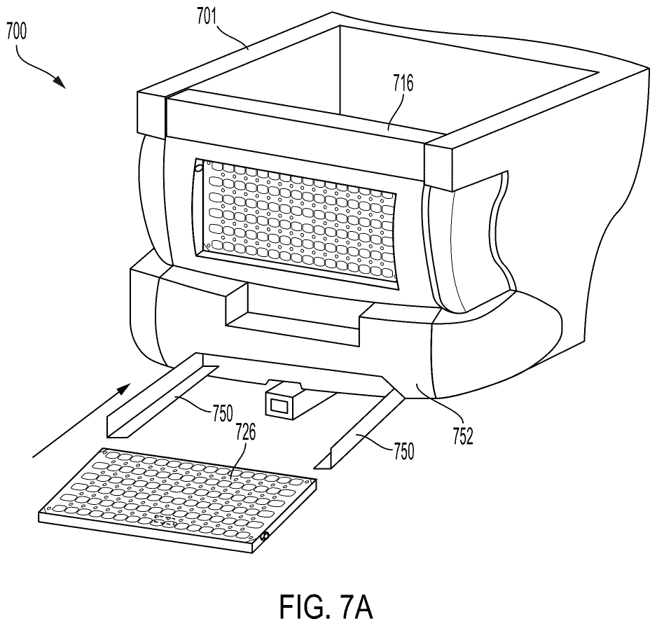

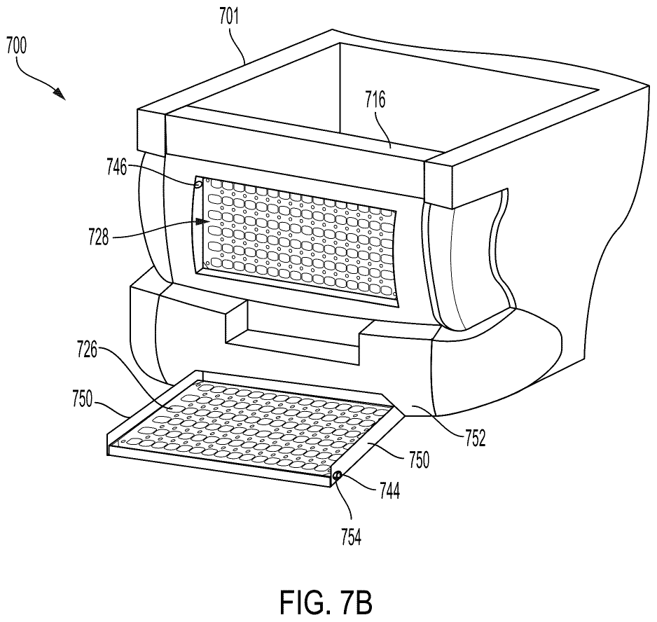

FIG. 7A and FIG. 7B show a tailgate assembly 700. The tailgate assembly 700 can be similar to the tailgate assembly 200 except that the tailgate assembly 700 further includes a pair of support rails 750 that extend from a rear bumper 752 of the vehicle 701. The tailgate panel cover 726 is removable from the tailgate panel 716 and configured to be received between, and supported by, the support rails 750. FIG. 7A shows the tailgate panel cover 726 removed/detached from the tailgate panel 716 and being moved toward the support rails 750. FIG. 7B shows the tailgate panel cover 726 installed to the support rails 750.

The support rails 750 can be telescoping rails configured to move between an extended position, wherein the support rails 750 extend aft of the rear bumper 752, and a retracted position, wherein the support rails 750 are flush with, nested in, and/or extend forward of, the rear bumper 752. In various aspects, the supports rails 750 can be pivotally coupled to the rear bumper 752. For example, the supports rails 750 can be folded against or into the rear bumper 752.

In various aspects, each support rail 750 can be in a right-angle shape, such as an L-shape. For example, the support rail 750 can be in the form of an angle iron including an elongated L-shaped member having a vertical leg and a horizontal leg. The tailgate panel cover 726 can be supported over the horizontal legs of the support rails 750. The tailgate panel cover 726 can be supported between the vertical legs of the support rails 750.

In various aspects, and with particular focus on FIG. 7B, each support rail 750 can include a latch aperture 754 configured to receive a latch bolt 744 of the tailgate panel cover 726. In various aspects, the latch bolt 744 can be similar to the latch bolt 544 described with respect to FIG. 5. In this manner, the latch bolt 744 can be used for securing the tailgate panel cover 726 to the support rails 750. In various aspects, the latch bolt 744 is configured to be received into a latch aperture 746 disposed in the tailgate panel 716. The latch aperture 746 can be disposed in a sidewall of the recess 728. The latch bolt 744 can be received in the latch aperture 746 for securing the tailgate panel cover 726 in a stowed position with respect to the tailgate panel 716 (e.g., see FIG. 9). In this regard, the latch bolt 744 can be used for securing the tailgate panel cover 726 in both the stowed position, wherein the tailgate panel cover 726 is disposed in the recess 728 in a vertical orientation, and the deployed position, wherein the tailgate panel cover 726 is supported by the support rails 750 in a horizontal orientation.

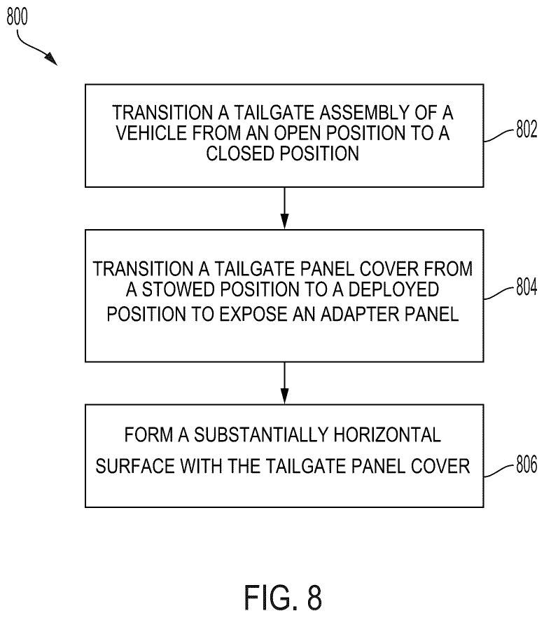

FIG. 8 is a flow diagram of an example process 800 for using a tailgate assembly for a vehicle. For ease of description, the process 800 is described below with reference to FIGS. 1-7B. The process 800 of the present disclosure, however, is not limited to use of the exemplary tailgate systems of FIGS. 1-7B.

At step 802, the tailgate assembly 200 of the vehicle 100 can be transitioned from an open position (see FIG. 2B) to a closed position (see FIG. 2A and FIG. 2C). For example, a user can manually close the tailgate assembly 200 or the tailgate assembly 200 can close via an automated process using one or more electric motors.

At step 804, the tailgate panel cover 226 of the tailgate assembly 200 can be moved with respect to the tailgate panel 216 of the tailgate assembly 200 from a stowed position (see FIG. 2A) to a deployed position (see FIG. 2C, FIG. 6, and FIGS. 7A-7B). For example, a user can manually move the tailgate panel cover 226 or the tailgate panel cover 226 can be moved via an automated process using one or more motors. In various aspects, the tailgate panel cover 226 remains pivotally coupled to the tailgate panel 216 and is rotated from the vertical position (folded against the tailgate panel 216) to the horizontal position (folded away from the tailgate panel 216). In various aspects, the tailgate panel cover 226 is released from the tailgate panel 216 and is moved to couple with the support rails 750 (see FIGS. 7A-7B).

At step 806, the tailgate panel cover 226 can form a substantially horizontal surface (e.g., see the second surface 236) in response to the tailgate panel cover 226 transitioning to the deployed position. The horizontal surface is configured to support cargo and/or provide a tie-down surface for transporting with the vehicle.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.”

What is claimed is:

1. A vehicle comprising:
a tailgate assembly comprising:
a tailgate panel movable between an open position and a closed position, the tailgate panel includes a first tailgate surface facing outward when the tailgate panel is in the closed position and a second tailgate surface facing inward when the tailgate panel is in the closed position;
a tailgate panel cover operatively coupled to the tailgate panel and disposed at the first tailgate surface, the tailgate panel cover is moveable with respect to the tailgate panel between a stowed position and a deployed position, the tailgate panel includes a first adapter panel having first and second surfaces; and
in response to the tailgate panel cover moving to the stowed position, the first adapter panel is disposed between the first tailgate surface and the tailgate panel cover.

2. The vehicle of claim 1, wherein, in response to the tailgate panel cover moving to the stowed position, the first adapter panel is hidden from view behind the tailgate panel cover.

3. The vehicle of claim 1, further comprising at least one series of apertures extending completely through the first and second surfaces of the first adapter panel, the at least one series of apertures is sized and configured for receiving a strap for securing an object to the tailgate panel cover, and the at least one series of apertures is sized and positioned to engage at least one attachment strap for securing the object against one of the first or second surfaces of the first adapter panel.

4. The vehicle of claim 1, wherein the tailgate panel cover is pivotally coupled to the tailgate panel, in the stowed position the tailgate panel cover is folded against the tailgate panel, and in the deployed position the tailgate panel cover is folded away from the tailgate panel.

5. The vehicle of claim 1, further comprising a second adapter panel coupled to the first tailgate surface of the tailgate panel, the second adapter panel is configured for securing an object to the tailgate panel cover, the tailgate panel cover is configured to cover the second adapter panel in response to the tailgate panel cover moving to the stowed position.

6. The vehicle of claim 1, further comprising a pair of rails configured to extend aft from a rear bumper of the vehicle, the pair of rails includes a first rail and a second rail, and in the deployed position the tailgate panel cover is configured to extend between and to the first rail and the second rail.

7. The vehicle of claim 6, wherein the tailgate panel cover includes a release handle operatively coupled to a latch bolt for moving the latch bolt between an extended position and a retracted position, the latch bolt is configured to engage the tailgate panel for locking the tailgate panel cover to the tailgate panel.

8. The tailgate assembly of claim 7, wherein the latch bolt is configured to engage at least one of the first rail or the second rail for locking the tailgate panel cover to the at least one of the first rail or the second rail in the deployed position.

9. The vehicle of claim 1, further comprising a spring-loaded hinge pin configured to engage the tailgate panel for pivotally coupling the tailgate panel cover to the tailgate panel, the spring-loaded hinge pin is retractable for releasing the tailgate panel cover from the tailgate panel.

10. A tailgate assembly for a vehicle, comprising:
a tailgate panel movable between an open position and a closed position, the tailgate panel includes a first tailgate surface facing outward when the tailgate panel is in the closed position and a second tailgate surface facing inward when the tailgate panel is in the closed position;
a tailgate panel cover operatively coupled to the tailgate panel and disposed at the first tailgate surface, the tailgate panel cover is moveable with respect to the tailgate panel between a stowed position and a deployed position, the tailgate panel includes a first adapter panel having first and second surfaces; and
in response to the tailgate panel cover moving to the stowed position, the first adapter panel is disposed between the first tailgate surface and the tailgate panel cover.

11. The tailgate assembly of claim 10, wherein, in response to the tailgate panel cover moving to the stowed position, the first adapter panel is hidden from view behind the tailgate panel cover.

12. The tailgate assembly of claim 10, further comprising at least one series of apertures extending completely through the first and second surfaces of the first adapter panel, and the at least one series of apertures is sized and configured for receiving a strap for securing an object to the tailgate panel cover.

13. The tailgate assembly of claim 12, wherein the at least one series of apertures is sized and positioned to engage at least one attachment strap for securing the object against one of the first or second surfaces of the first adapter panel.

14. The tailgate assembly of claim 10, wherein the tailgate panel cover is pivotally coupled to the tailgate panel, in the stowed position the tailgate panel cover is folded against the tailgate panel, and in the deployed position the tailgate panel cover is folded away from the tailgate panel.

15. The tailgate assembly of claim 10, further comprising a second adapter panel coupled to the first tailgate surface of the tailgate panel, the second adapter panel is configured for securing an object to the tailgate panel cover, the tailgate panel cover is configured to cover the second adapter panel in response to the tailgate panel cover moving to the stowed position.

16. The tailgate assembly of claim 10, further comprising a pair of rails configured to extend aft from a rear bumper of the vehicle, the pair of rails includes a first rail and a second rail, and in the deployed position the tailgate panel cover is configured to extend between and to the first rail and the second rail.

17. The tailgate assembly of claim 16, wherein the first and second rails are telescoping rails.

18. The tailgate assembly of claim 16, wherein the tailgate panel cover includes a release handle operatively coupled to a latch bolt for moving the latch bolt between an extended position and a retracted position, the latch bolt is configured to engage the tailgate panel for locking the tailgate panel cover to the tailgate panel.

19. The tailgate assembly of claim 18, wherein the latch bolt is configured to engage at least one of the first rail or the second rail for locking the tailgate panel cover to the at least one of the first rail or the second rail in the deployed position.

20. A method of using a tailgate assembly for a vehicle, the method comprising:
with the tailgate assembly in a closed position, transitioning a tailgate panel cover from a stowed position to a deployed position to expose an adapter panel having first and second surfaces and at least one series of apertures extending completely through the first and second surfaces of the adapter panel; and
forming a substantially horizontal surface with the tailgate panel cover in response to the tailgate panel cover transitioning to the deployed position, and the horizontal surface is configured to support cargo for transporting with the vehicle.
